(19) United States
(12) Patent Application Publication
(10) Pub. No.: US 2024/0042892 A1
(43) Pub. Date: Feb. 8, 2024

(54) UNLOCKING APPARATUS, SWAPPING DEVICE COMPRISING SAME, AND UNLOCKING CONTROL METHOD

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Shanghai (CN); Yi Ji, Shanghai (CN); Chao Wen, Shanghai (CN); Yingfu Zhou, Shanghai (CN)

(21) Appl. No.: 18/014,478

(22) PCT Filed: Jul. 6, 2021
(86) PCT No.: PCT/CN2021/104837

§ 371 Date: Jul. 3, 2023

(30) Foreign Application Priority Data
Jul. 6, 2020 (CN) 202010642719.0
Jul. 6, 2020 (CN) 202010643298.3

(51) Int. Cl. B60L 53/80; E05B 77/00; E05B 81/06; E05B 81/16; E05B 81/30; E05B 81/72; H01M 50/264; H01M 50/249

(52) U.S. Cl. CPC B60L 53/80; E05B 77/00; E05B 81/06; E05B 81/16; E05B 81/30; E05B 81/72; H01M 50/264; H01M 50/249; H01M 2220/20

(57) ABSTRACT

Disclosed are an unlocking apparatus, a swapping device comprising same, and an unlocking control method. The unlocking apparatus is used for unlocking or locking a battery box in a battery bracket on an electric vehicle, and comprises a drive mechanism, an unlocking component, and a transmission member. The drive mechanism drives the unlocking component to move by means of the transmission member, so that the unlocking component drives a locking mechanism on the battery bracket to move to unlock or lock the battery box; the unlocking component is axially rotatable relative to the transmission member to adapt to the angle deviation between the unlocking component and the standard unlocking position on the battery bracket. The swapping device comprises the unlocking apparatus. In this way, even if there is a circumferential deviation, the unlocking component is ensured to be accurately aligned and connected.

The present application claims the priority of Chinese patent application 2020106427190 filed on Jul. 6, 2020, and the priority of Chinese patent application 2020106432983 filed on Jul. 6, 2020. The contents of the Chinese patent application are incorporated herein by reference in their entireties.

### TECHNICAL FIELD

The present disclosure relates to unlocking apparatus, swapping device comprising same, and unlocking control method.

### BACKGROUND

Due to the shortage of petroleum resources and people's increasing awareness of environmental protection, the use of electric vehicles is becoming more and more widespread, and has become a trend. In order to cooperate with the use of electric vehicles, a swapping station has also emerged as the times require. In the swapping station, the battery box of the electric vehicle can be quickly swapped by a swapping robot.

In the prior art, the unlocking apparatus of the swapping robot used to disassemble and separate the battery box on the electric vehicle from the electric vehicle adopts a structure that integrates the suction cup and the unlocking mechanism, that is, the unlocking apparatus is directly arranged in the suction cup, and the side of the outer shell of the battery box opposite to the unlocking apparatus is arranged with a corresponding unlocking member. When unlocking the battery box from the electric vehicle, after the suction cup is connected to the battery box by adsorption, the unlocking mechanism acts on the unlocking member on the outer shell of the battery box to drive the unlocking piece to move in order to complete the disassembly action of the battery box, this unlocking method needs to directly arrange the unlocking member on the outer shell of the battery box, which affects the strength and sealing of the outer shell, and when the unlocking member is driven to move, it is easy to cause the outer shell to deform, thereby affecting the service life of the battery box, and the point-to-point contact between the unlocking apparatus and the unlocking member, in the actual unlocking process, it is easy to cause problems such as poor alignment accuracy, unlocking failure, and low swapping efficiency.

### CONTENT OF THE PRESENT INVENTION

An unlocking apparatus, it is used for unlocking or locking the battery box in the battery bracket on the electric vehicle, the unlocking apparatus comprises a drive mechanism, an unlocking component, and a transmission member, the drive mechanism drives the unlocking component to move by means of the transmission member, so that the unlocking component drives a locking mechanism on the battery bracket to move to unlock or lock the battery box;

the unlocking component is axially rotatable relative to the transmission member to self-adapt to the angle deviation between the unlocking component and the standard unlocking position on the battery bracket.

In this solution, the unlocking component drives the locking mechanism on the battery bracket to move to unlock or lock the battery box, thereby avoiding the unlocking component directly acting on the outer shell of the battery box, not affecting the strength of the outer shell of the battery box, and prolonging the service life of the battery box. At the same time, the unlocking component can be rotated and adjusted in its circumferential direction when connected, that is, when the position deviation between the unlocking component and the unlocking matching part is within the preset deviation range, the connection matching with the unlocking matching part can be realized by means of the axial rotation of the unlocking component itself, and the position of the unlocking component does not need to be adjusted again by external force, so that the connection matching between the unlocking component and the unlocking matching part can be ensured even if there is circumferential position deviation. After that, the drive mechanism drives the transmission member and the unlocking component to move to drive the locking mechanism, so as to realize the unlocking or locking of the battery box, and the unlocking or locking accuracy is very high, thus improving the swapping efficiency; a misoperation is effectively avoided, and the safety and stability of the swapping device are greatly improved.

A swapping device comprises an unlocking apparatus as described above.

In this solution, by adopting the structure form, the accurate alignment and connection of the unlocking components can be ensured even if there is a circumferential position deviation, thereby realizing unlocking or locking of the battery box, having very high unlocking or locking accuracy and improving the swapping efficiency; a misoperation is effectively avoided, and the safety and stability of the swapping device are greatly improved.

Preferably, the swapping device further comprises a battery tray, and the unlocking apparatus is connected to the battery tray.

In this solution, the above structure is adopted, the top of the battery tray is used to place the battery box, and the unlocking apparatus is installed on the bottom surface of the battery tray, so as to unlock or lock the battery box in the battery bracket on the electric vehicle.

An unlocking control method, which unlocks or locks a battery box in a battery bracket on an electric vehicle by means of an unlocking member on a swapping device, the battery bracket is provided with a locking mechanism and an unlocking matching part, and the locking mechanism is used for locking the battery box in the battery bracket, the unlocking matching part is connected with the locking mechanism and used to drive the locking mechanism to switch between an unlocked state and a locked state, and the unlocking control method comprises:
controlling the unlocking member to move along the unlocking matching part approaching to the battery bracket;
controlling the rotation of the unlocking member to drive the rotation of the unlocking matching part to realize the unlocking or locking of the battery box.

In this solution, the rotation of the unlocking member is used to drive the rotation of the unlocking matching part, so as to realize the unlocking or locking of the battery box. The unlocking or locking accuracy is very high, which improves the swapping efficiency; a misoperation is avoided effectively, and the safety and stability of the swapping device during the unlocking or locking process is improved. At the same time, it avoids that the unlocking member acts directly on the outer shell of the battery box, which will not affect the strength of the outer shell of the battery box, and improves the service life of the battery box.

The positive progress effect of the present invention is:

The unlocking apparatus of the present invention and the swapping device including it can rotate axially by means of the unlocking component relative to the transmission member, so as to adapt to the angle deviation between the unlocking component and the standard unlocking position on the battery bracket. The unlocking components can be rotated and adjusted in its circumferential direction when they are connected, so that even if there is a circumferential position deviation, the unlocking components can be accurately aligned and connected. At the same time, the drive mechanism drives the transmission member and the unlocking component to move to drive the locking mechanism to unlock or lock the battery box. The unlocking or locking accuracy is very high, which improves the swapping efficiency; and a misoperation can be effectively avoided, and the safety and stability of the swapping device are greatly improved. And the locking mechanism on the battery bracket is driven by the unlocking component to unlock or lock the battery box, which prevents the unlocking component from directly acting on the outer shell of the battery box, does not affect the shell strength of the battery box, and improves the service life of the battery box. The unlocking control method of the present invention drives the unlocking matching part to rotate by means of the rotation of the unlocking member, thereby realizing the unlocking or locking of the battery box, the unlocking or locking precision is very high, and the efficiency of battery replacement is improved; misoperation is effectively avoided, which greatly improves the safety and stability of the swapping device during the unlocking or locking process. At the same time, it avoids that the unlocking member acts directly on the outer shell of the battery box, which will not affect the strength of the outer shell of the battery box, and improves the service life of the battery box.

### BRIEF DESCRIPTION OF THE DRAWINGS

FIG. 1 is a flowchart of an unlocking control method according to an embodiment of the present invention.

FIG. 2 is a partial structural schematic diagram of a swapping device according to an embodiment of the present invention.

FIG. 3 is a schematic structural diagram of an unlocking apparatus according to an embodiment of the present invention.

FIG. 4 is a schematic diagram of the internal structure of the unlocking apparatus according to the embodiment of the present invention.

FIG. 5 is a schematic structural diagram of an unlocking matching member according to an embodiment of the present invention.

FIG. 6 is a schematic diagram of an exploded structure of an angle deviation between the unlocking apparatus and the unlocking matching member according to the embodiment of the present invention.

FIG. 7 is a schematic structural view of the unlocking apparatus inserted into the unlocking matching member according to the embodiment of the present invention.

FIG. 8 is a structural schematic diagram of an axis deviation between the unlocking member and the unlocking matching part according to the embodiment of the present invention.

### DETAILED DESCRIPTION OF THE PREFERRED EMBODIMENT

The present invention will be more clearly and completely described below by means of embodiments and in conjunction with the accompanying drawings, but the present invention is not limited to the scope of the embodiments.

As shown in FIG. 2 to FIG. 8, the embodiment of the present invention provides a swapping device, which is used for side swapping of an electric vehicle, and the battery box is installed in the installing space on both sides of the bottom of the electric vehicle by means of a battery bracket, the swapping device unlocks the used battery box on the battery bracket and takes out the used battery box from the battery bracket, or puts the new battery box into the battery bracket, and locks the new installed battery box.

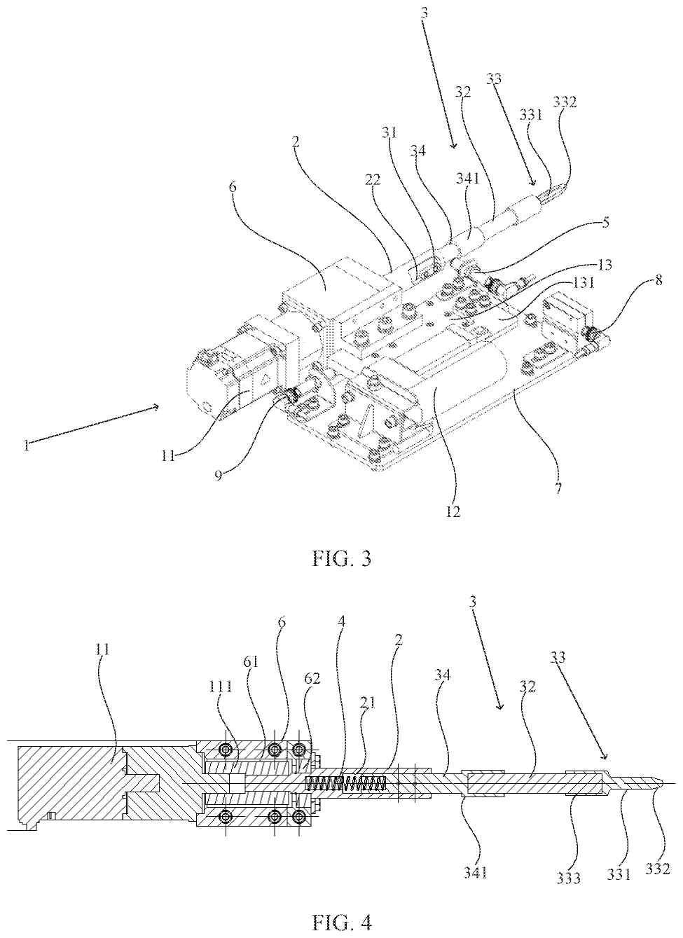

The swapping device comprises a frame 100, a lifting mechanism 200, an unlocking apparatus, a battery tray 300, and a push tray box 400, the lifting mechanism 200 moves up and down in the frame 100, and the battery tray 300 is arranged on the lifting mechanism 200, and the battery tray 300 can be telescopically moved relative to the lifting mechanism 200, and the battery tray 300 is rotatably or reversibly connected to the lifting mechanism 200. The tray push tray box 400 can telescopically move on the battery tray 300 and is used to connect the battery box. The unlocking apparatus is arranged on the bottom of the battery tray 300. In FIG. 3, only the structure of the lower part of the frame 100 is shown, and the structure of the upper part is omitted.

The lifting mechanism 200 comprises a car, which moves up and down along the frame 100 by means of a sprocket chain, the car comprises side plates arranged opposite to each other, and the limit buffer unit 3 is arranged near the bottom or top of the side plates.

The unlocking apparatus is arranged at the bottom of the battery tray 300. During the swapping operation of the swapping device, the battery tray 300 will telescopically move in the telescopic direction when extending out to take and place the battery box, and the telescopic direction is in the width direction of the electric vehicle. The top of the battery tray 300 is used for placing a battery box, the push tray box 400 and the battery box can be connected or disconnected, the unlocking device is installed on the bottom surface of the battery tray 300, and the unlocking apparatus is used for unlocking or locking the battery box in the battery bracket on the electric vehicle.

The unlocking apparatus comprises a drive mechanism 1, an unlocking component 3 and a transmission member 2, wherein the drive mechanism 1 drives the unlocking component 3 to move by means of the transmission member 2, so that the unlocking component 3 drives the locking mechanism on the battery bracket to move to realize unlocking or locking the battery box; the unlocking component 3 is axially rotatable relative to the transmission member 2 to self-adapt the angular deviation between the unlocking component 3 and the standard unlock position on the battery bracket. In this embodiment, locking, unlocking and driving of the battery box on the battery bracket are realized in a rotating manner, and in other embodiments, locking, unlocking and driving can also be realized in other motion modes, such as axial expansion and contraction, radial displacement, etc.

The drive mechanism 1 is installed and connected to the battery tray 300, and the drive mechanism 1 drives the transmission member 2 and the unlocking component 3 to rotate. The unlocking component 3 and the unlocking matching member 500 of the locking mechanism are matched and connected to each other and rotate together, thereby realizing the unlocking or locking the battery box. The locking mechanism on the battery bracket is driven by the unlocking component 3 to unlock or lock the battery box, which avoids the direct action of the unlocking component 3 on the outer shell of the battery box, does not affect the strength of the outer shell of the battery box, and improves the service life of the battery box. At the same time, through the axial rotation of the unlocking component 3 relative to the transmission member 2 to self-adapt the angular deviation between the unlocking component 3 and the standard unlocking position on the battery bracket, so that the unlocking component 3 to be rotated and adjusted in its circumferential direction when connected. That is, when the position deviation between the unlocking component 3 and the unlocking matching member 500 is within the preset error range, through the axial rotation of the unlocking component 3 itself to realize the connection and matching with the unlocking matching member 500, without requiring external force to adjust the position of the unlocking component 3 again, to ensure the connection and matching between the unlocking component 3 and the unlocking matching member 500 even if there is a circumferential position deviation. After that, the drive mechanism 1 drives the transmission member 2 and the unlocking component 3 to drive the locking mechanism to move, thereby realizing the unlocking or locking of the battery box. The unlocking or locking accuracy is very high, which improves the efficiency of the swapping; a misoperation is effectively avoided, and the safety and stability of the swapping device are greatly improved.

Wherein, the battery box may have a locking slot, and the locking mechanism comprises a rotating insert, which is arranged on the battery bracket, and the rotating insert is connected to the unlocking matching member 500. The movement of the unlocking component 3 drives the movement of the unlocking matching member 500, and the movement of the unlocking matching member 500 will drive the rotating insert to rotate, depending on the different direction of rotation, the rotating insert can be inserted into or retracted out of the locking slot on the battery box, so as to realize the locking or unlocking of the battery box. The specific structure of the locking mechanism is not limited in this embodiment.

As shown in FIG. 3, one end of the transmission member 2 is connected to the drive mechanism 1, and the other end of the transmission member 2 is rotatably connected to the unlocking component 3. A rotatable connection can be adopted between the transmission member 2 and the unlocking component 3, so that when the unlocking component 3 is connected to the unlocking matching member 500, the relative rotation between the unlocking component 3 and the transmission member 2 can be achieved. By the rotation of the unlocking component 3 itself to adapt to the angular deviation between the unlocking component 3 and the unlocking matching member 500, so as the unlocking component 3 is inserted into the unlocking matching member 500 and the unlocking apparatus has higher stability in the process of unlocking or locking.

The unlocking component 3 can move on the transmission member 2 along the axial direction of the unlocking component 3. The unlocking component 3 can rotate and move axially relative to the transmission member 2, which improves the flexibility of the movement of the unlocking component 3 so as to realize the connection and matching with the unlocking matching member 500.

As shown in FIG. 4, the transmission member 2 has a guide hole 21, the guide hole 21 is recessed inward from the end of the transmission member 2 towards the unlocking component 3 along the axial direction of the transmission member 2, the unlocking component 3 is inserted into the guide hole 21 and can move in the guide hole 21. The guide hole 21 performs a guiding function, so that the unlocking component 3 moves along the axial direction of the transmission member 2 in the guide hole 21, effectively avoiding the displacement and dislocation of the unlocking component 3 during the movement process, and greatly improving the security and stability of the swapping device.

The unlocking apparatus further comprises a first elastic member 4 located in the guide hole 21, and two ends of the first elastic member 4 abut against the transmission member 2 and the unlocking component 3 respectively. By means of the first elastic member 4 abutting against the unlocking component 3 and exerting a force on the unlocking component 3 approaching to the direction of the locking mechanism, when the unlocking component 3 enters the predetermined position in the unlocking matching member 500 on the battery bracket, the unlocking component 3 will receive the force from the unlocking matching member 500 and move in the guide hole 21 in the direction approaching to the drive mechanism 1. During the movement of the unlocking component 3 to the drive mechanism, the first elastic member 4 will be compressed; after the unlocking component 3 leaves from the unlocking matching member 500, the first elastic part 4 will drive the unlocking component 3 to return to the initial position. By means of the first elastic member 4 exerts a force on the unlocking component 3 and has a certain amount of displacement, so that when the unlocking component 3 accidentally touches, the force of the first elastic member 4 will not cause too large displacement of the unlocking component 3 moving approaching to the drive mechanism 1, which effectively avoids misoperation of the unlocking apparatus, and effectively avoids hard collision between the unlocking component 3 and the transmission member 2, greatly improving the safety and stability of the unlocking apparatus. At the same time, the first elastic member 4 is arranged in the guide hole 21, which has higher stability. Wherein, the first elastic member 4 may be a spring.

One end of the transmission member 2 approaching the unlocking component 3 is clamped with the unlocking component 3. The transmission member 2 and the unlocking component 3 are connected in a clamping manner, which avoids the separation of the transmission member 2 and the unlocking component 3, and has high safety and stability.

In this embodiment, the end of the transmission member 2 approaching the unlocking component 3 has a limiting portion, the unlocking component 3 is provided with a matching portion, the matching portion is connected in the limiting portion and can rotate along the axis of the unlocking component 3 relative to the limiting portion. The transmission member 2 is clamped with the matching portion on the unlocking component 3 by means of the limiting part, and the limiting portion performs a limiting function, so that the matching portion rotates along the axis of the unlocking component 3 in the limiting portion, so that the unlocking component 3 can be rotated and adjusted, and the unlocking component 3 is inserted into the unlocking matching member 500 to realize higher stability of the unlocking apparatus in the process of unlocking or locking.

The limiting portion is an opening 22 arranged on the outer wall of the transmission member 2, and the opening 22 communicates with the guide hole 21. A guide hole 21 is provided at the end of the transmission member 2, and an opening 22 is arranged on the outer wall of the transmission member 2, so as to limit the movement of the unlocking component 3.

The matching portion is a slider 31 arranged on the unlocking component 3. The slider 31 will be able to rotate along the axis of the unlocking component 3 in the opening 22, and the slider 31 is clamped and connected in the opening 22 to limit the axial rotation angle and moving distance of the unlocking component 3, so that the angular deviation between the unlocking component 3 and the unlocking matching part 3 can be adaptively adjusted, at the same time, the unlocking component 3 can drive to rotate at a preset angle to realize the locking or unlocking of the battery box, avoiding the separation of the unlocking component 3 from the transmission member 2, and improving the efficiency and stability of the unlocking or locking process.

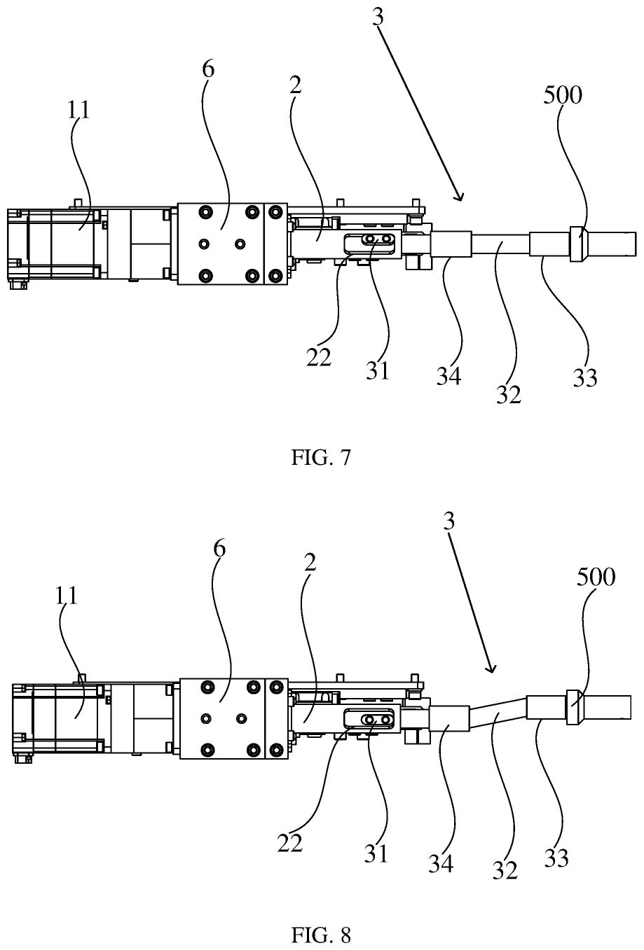

As shown in FIG. 6 and FIG. 7, the length of the opening 22 along the axial direction of the transmission member 2 is greater than the extension length of the slider 31 along the axial direction of the transmission member 2. In this way, the slider 31 can move in the axial direction of the transmission member 2 in the opening 22, and the hard collision between the slider 31 and the transmission member 2 is effectively avoided when the unlocking apparatus is misoperated, which greatly improves the safety and stability of the unlocking apparatus.

The length of the opening 22 in the radial direction of the transmission member 2 is greater than the extension length of the slider 31 in the radial direction of the transmission member 2. By means of the above settings, the opening 22 reserves an self-adaptive rotation space for the unlocking component 3, so that when there is a slight angular deviation between the unlocking component 3 and the unlocking matching member 500, the unlocking component 3 and the unlocking matching member 500 can interact with each other, so that the unlocking component 3 itself rotates to adjust the angular deviation between it and the unlocking matching member 500, perform radial position alignment, and realize connection and matching with the unlocking matching member 500.

In FIG. 6, before the unlocking component 3 is inserted into the unlocking matching member 500, there is an angular deviation between the unlocking component 3 and the unlocking matching member 500, and the slider 31 is located in the middle of the opening 22 in the circumferential direction. In FIG. 7, the unlocking component 3 will move in the direction approaching to the unlocking matching member 500 and be inserted into the unlocking matching member 500, the unlocking component 3 can rotate axially relative to the transmission member 2, and the slider 31 will move along the circumference in the opening 22 and be arranged at one end of opening 22.

Of course, in other embodiments, the end of the transmission member 2 approaching the unlocking component 3 comprises a matching portion, and the unlocking component 3 is arranged with a limiting portion, the limiting portion is connected in the matching portion and can move along the axis of the unlocking component 3 relative to the matching portion. That is, an opening is arranged on the unlocking component 3, and a slider is arranged on the transmission member 2. As long as the unlocking component 3 and the transmission member 2 can rotate in the circumferential direction and move in the axial direction, the specific structure may not be limited.

There is not only rotation adjustment between unlocking component 3 and transmission member 2 in the circumferential direction of unlocking component 3, but also inaccurate alignment of the axis of unlocking component 3 and the axis of unlocking matching member 500 between unlocking component 3 and unlocking matching member 500, that is, there is a slight position deviation and not on the same straight line. In order to achieve the situation that the unlocking apparatus can adapt to the inaccurate alignment. As shown in FIG. 8, the unlocking component 3 itself can displace radially, so that the unlocking component 3 can move radially relative to the drive mechanism 1. When the drive mechanism 1 is fixed, the unlocking component 3 itself can be displaced in the radial direction, so that the unlocking component 3 can be matched and inserted into the unlocking matching member 500, so that the unlocking apparatus has a higher stability in the unlocking or locking process.

The unlocking component 3 comprises a radially twistable second elastic member 32 and an unlocking member 33, both ends of the second elastic member 32 are respectively connected to the transmission member 2 and the unlocking member 33, and the second elastic member 32 is adapted to the radial displacement of the unlocking member 33. The second elastic member 32 can be twisted in the radial direction, so that the unlocking member 33 can move in the radial direction relative to the transmission member 2. At the same time, the transmission member 2, the second elastic member 32 and the unlocking member 33 are connected in sequence to ensure that the unlocking apparatus is connected in the axial direction and rotates around its axis, with higher stability, simple structure, and convenient installation and connection.

The end of the unlocking member 33 approaching away from the transmission member 2 comprises an insertion end, and the insertion end is used to connect and match the unlocking matching member 500 on the locking mechanism on the battery bracket. The battery tray 300 will drive the unlocking apparatus to extend out synchronously during the extension process, and the insertion end of the unlocking member 33 will be connected and matched with the unlocking matching member 500 by inserting, so as to drive the unlocking member 33 to rotate to drive the rotation of the unlocking matching member 500, and then realize the unlocking or locking of the locking mechanism. After the operation is completed, the retraction of the battery tray 300 will drive the insertion end and the unlocking matching member 500 to disconnect from each other, thereby realizing separation. It is very convenient to connect and disconnect, has high stability, and at the same time, comprises a simple structure.

The outer surface of the insertion end has at least one abutment surface 331, the battery bracket is arranged with an unlocking matching member 500, the unlocking matching member 500 is connected to the locking mechanism, the insertion end is used for inserting into the unlocking matching member 500, and the abutment surface 331 and the inner wall surface of the unlocking matching member 500 are matched so as to drive the unlocking matching member 500 to rotate. When the unlocking member 33 rotates, the abutment surface 331 matches the inner wall surface of the unlocking matching member 500, so that the abutting surface 331 will exert a force on the unlocking matching member 500 and drive the unlocking matching member 500 to rotate, thereby driving the locking mechanism to rotate to unlock or lock the battery box. The abutting surface 331 exerts force on the inner wall surface of the unlocking matching member 500 to drive the unlocking matching member 500 to rotate, and the rotation stability is high. In this embodiment, the number of abutment surfaces 331 is multiple, and as long as the shape enclosed by the plurality of abutment surfaces 331 is non-circular, it can drive the unlocking matching member 500 to rotate, by a square structure surrounded by the plurality of abutment surfaces 331, even if the unlocking member 33 has a deviation in the circumferential position, it only needs to rotate a small angle to achieve accurate alignment and connection of the unlocking component 3. Of course, in other embodiments, the number of the abutting surfaces 331 may not be limited.

The end of the insertion end approaching away from the transmission member 2 has a sliding guide surface 332 connected to the abutting surface 331 and used for guiding the unlocking member 33 to be inserted into the unlocking matching member 500. The sliding guide surface 332 performs a sliding guiding function, and the slight positional deviation between the unlocking member 33 and the unlocking matching member 500 can be adapted by means of the sliding guide surface 332; when the insertion end is inserted into the unlocking matching member 500, the sliding guide surface 332 performs sliding guiding function firstly and inserts into the unlocking matching member 500, so that the abutting surface 331 can be stably entered into the unlocking matching member 500 even if there is a slight positional deviation of the insertion end. In this embodiment, one end of the sliding guide surface 332 is connected to the abutting surface 331, and the other end extends obliquely relative to the abutting surface 331 toward the axis of the unlocking member 33 and away from the abutting surface 331.

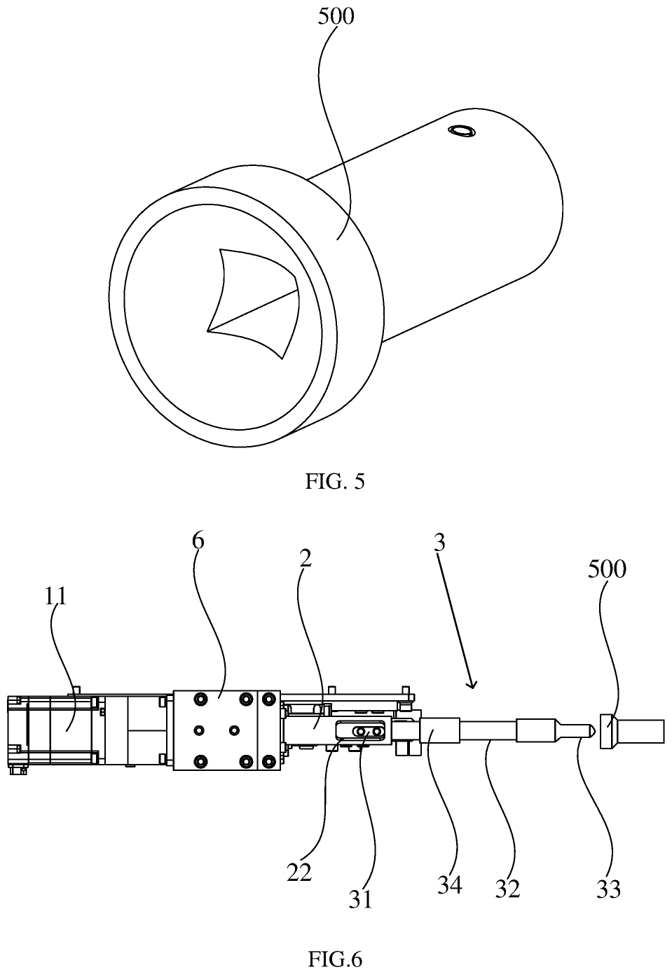

As shown in FIG. 3, FIG. 4, FIG. 5, FIG. 6, FIG. 7 and FIG. 8, when the unlocking component 3 is inserted into the unlocking matching member 500, when there is an angular deviation between the unlocking member 33 and the unlocking matching member 500, the slider 31 is located in the opening 22 and can rotate and move in the opening 22, so that the unlocking component 3 can rotate axially relative to the transmission member 2, thereby solving the problem of angular deviation and realizing angular alignment. When there is an axis deviation between the unlocking member 33 and the unlocking matching member 500, the unlocking member 33 and the unlocking matching member 500 contacts to each other, and the unlocking member 33 will slide into the unlocking matching member 500 by means of the sliding guide surface 332, and, since the second elastic member 32 can be radially twisted, even if there is an axis deviation between the unlocking component 3 and the unlocking matching member 500, it can ensure that the unlocking member 33 enters the unlocking matching member 500 stably. After the unlocking member 33 is inserted into the unlocking matching member 500 to the end, the drive mechanism 1 continues to drive the unlocking component 3 to move toward the unlocking matching member 500, so that the slider 31 moves in the opening 22 toward the drive mechanism 1.

One end of the unlocking member 33 approaching the second elastic member 32 comprises a connecting groove 333 extending along the axial direction of the unlocking member 33, and the unlocking member 33 is connected to the second elastic member 32 by means of the connecting groove 333. By the connecting groove 333, the insertion of the second elastic member 32 into the connecting groove 333 can realize the connection between the unlocking member 33 and the second elastic member 32, which is convenient for installation and connection. At the same time, the unlocking component 3 is arranged in its axial direction, which ensures that the unlocking component 3 rotates along its axis, and realizes higher stability of the unlocking apparatus in the unlocking or locking process.

The unlocking component 3 further comprises a connecting sleeve 34, one end of the connecting sleeve 34 is connected to the second elastic member 32, and the other end of the connecting sleeve 34 is connected to the transmission member 2. The transmission member 2 and the second elastic member 32 are sequentially connected by means of the connecting sleeve 34 to ensure that the unlocking apparatus is connected in the axial direction and twisted radially around the axis, with higher stability and convenient installation and connection. Wherein, the second elastic member 32 can be a flexible shaft, and the material of the connecting sleeve 34 and the unlocking member 33 can be metal.

The end of the connecting sleeve 34 approaching the transmission member 2 is rotatably connected with the transmission member 2. In this embodiment, the end of the connecting sleeve 34 will be inserted into the guide hole 21, the slider 31 is connected to the outer wall of the connecting sleeve 34 and located in the opening 22, and the length of the opening 22 along the radial direction of transmission member 2 is greater than the extension length of the slider 31 in the radial direction of the transmission member 2 makes the connecting sleeve 34 and the transmission member 2 rotatably connected. At the same time, the connecting sleeve 34 realizes a clamping connection with the opening 22 of the transmission member 2 by means of the slider 31, and the connection stability is high.

The unlocking apparatus further comprises a first detection unit 5 for detecting whether the unlocking component 3 moves in a direction approaching the drive mechanism 1. During the unlocking or locking process of the unlocking apparatus, the insertion end of the unlocking component 3 needs to be accurately aligned and inserted into the unlocking matching member 500, the unlocking component 3 is moved in a direction approaching to the drive mechanism 1 by the abutment force of the unlock matching member 500. If the first detection unit 5 detects the movement of the unlocking component 3 into the detection area of the first detection unit 5, it indicates that the insertion end is inserted into the unlocking matching member 500, and the next step of driving the unlocking component 3 to rotate can be continued. If the first detection unit 5 has not detected the unlocking component 3, it indicates that there is a misalignment between the unlocking component 3 and the unlocking matching member 500 and has not been inserted into the unlocking matching member 500. At this time, the unlocking component 3 can be controlled to stop moving in a direction approaching to the unlocking mating member 500.

By means of the first detection unit 5, it can be detected whether the unlocking component 3 is located in the unlocking position of the unlocking matching member 500, which greatly improves the safety and stability of the swapping device during the swapping process, and realizes precise control of the unlocking process, that is, after the unlocking member 33 reaches the unlocking position, the unlocking or locking operation is performed. The whole process is automatically and accurately controlled without manual adjustment, which improves the efficiency of unlocking, and at the same time prevents the collision and misoperation that the unlocking member 33 continues to move approaching to the battery bracket when the unlocking member 33 and the unlocking matching member 500 are misaligned.

A compressing portion 341 is also arranged on the unlocking component 3, and the first detection unit 5 is used to detect the position of the compressing part 341. When the unlocking component 3 is aligned and inserted into the unlocking matching member 500, it will drive the compressing portion 341 to move in a direction approaching to the drive mechanism 1. In this embodiment, the compressing portion 341 is located on the outer surface of the connecting sleeve 34 and extends outwards, and the first detection unit 5 detects whether the unlocking component 3 moves in the direction approaching to the drive mechanism 1 by detecting the distance from the connecting sleeve 34. In an initial state, the compressing portion 341 is not located in the detection area of the first detection unit 5. When the unlocking member 33 is inserted into the unlocking matching member 500, the compressing portion 341 will move toward the direction approaching to the drive mechanism to the detection area of the first detection unit 5, and the first detection unit 5 can detect the compressing portion 341, which means that the unlocking member 33 enters the unlocking matching member 500 and reaches the unlocking position; when the first detection unit 5 does not detect that the compressing portion 341 has moved to the detection area, it means that the unlocking member 33 is not aligned with the unlocking matching member 500, and the unlocking member 33 can be controlled in time to stop moving. The first detection unit 5 is used to detect the position of the compressing portion 341, the detection is accurate, misoperation is avoided, and the safety and stability of the swapping device are greatly improved. Wherein, the first detection unit 5 may be a sensor. Preferably, the first detection unit 5 may be a proximity sensor.

The drive mechanism 1 comprises a rotating unit 11 connected to the transmission member 2 by means of a coupling sleeve 111 and used for driving the unlocking component 3 to rotate along the axis of the unlocking component 3. The rotating unit 11 and the transmission member 2 are connected by means of the coupling sleeve 111, which is convenient for matching assembly connection, ensures that the transmission member 2 rotates along its axis, and realizes higher stability of the unlocking apparatus in the unlocking or locking process. Wherein, the rotating unit 11 may be a screw screwing machine.

The drive mechanism 1 further comprises a detection module (not shown in the figure) electrically connected to the rotating unit 11 and for detecting a rotational torque of the rotating unit 11. When the rotating unit 11 rotates, the detection module will detect whether the torque of the rotating unit 11 is within the standard torque range. If the detected torque is within the standard torque range, it means that the unlocking member 33 drives the unlocking matching member 500 to unlock or lock the locking mechanism on the battery bracket in place; if the detected torque is not within the standard torque range, it means that the locking mechanism is not unlocked or locked in place, at this time, the next operation of taking the battery box or disconnecting with the battery box cannot be carried out, so as to avoid the swapping fault caused by the battery box not being safely unlocked or locked, and further improve the safety and stability of the swapping device in the swapping process. Of course the detection of whether or not the unlocking member 33 is inserted into the unlocking matching member 500 can be determined by detecting whether or not the rotation amount of the rotating unit 11 when driving the unlocking member 33 to rotate falls within a preset rotation amount range. Wherein, the standard torque range comprises locking standard torque range and unlocking standard torque range, the locking standard torque range refers to a rotational torque at which the unlocking member 33 is inserted into the unlocking matching member 500 to rotate to drive the locking mechanism to lock the battery box, and the unlocking standard torque range refers to a rotational torque at which the unlocking member 33 is inserted into the unlocking matching member 500 to rotate to drive the locking mechanism to unlock the battery box.

The unlocking apparatus also comprises a mounting seat 6, and the rotating unit 11 is penetrated on the mounting seat 6. The rotating unit 11 is mounted and fixed on the mounting seat 6, so that the unlocking component 3 can be moved integrally, the mounting and setting are convenient, and the connection stability is high.

A limiting hole 61 is arranged in the mounting seat 6, and the transmission member 2 is inserted into the limiting hole 61 and connected to the rotating unit 11. The limiting hole 61 will performs a limiting function, effectively avoiding the deviation and dislocation phenomenon of the transmission member 2 in the rotation process, and greatly improving the safety and stability of the swapping device. Preferably, a bearing 62 is arranged in the limiting hole 61, and the bearing 62 is sleeved on the transmission member 2. The rotation of the transmission member 2 is ensured to be more stable by the bearing 62.

The drive mechanism 1 also comprises a driving unit 12 and a first mounting plate 13, the mounting seat 6 is connected to the first mounting plate 13, the driving unit 12 is connected to the first mounting plate 13 and is used to drive the first mounting plate 13 in the direction of the unlocking component 3 axial movement. Both the driving unit 12 and the first mounting plate 13 can be installed on the battery tray 300 and will move with the battery tray 300 approaching to the battery bracket, and the driving unit 12 drives the first mounting plate 13, so that the first mounting plate 13 can move relative to the battery tray 300 in the axial direction of the unlocking component 3, that is, moving in the direction approaching to the unlocking matching member 500 on the battery bracket, further ensures the precise cooperation between the unlocking component 3 and the unlocking matching member 500, and greatly improves the stability of the swapping device.

The unlocking apparatus further comprises a second mounting plate 7, on which the driving unit 12 is arranged, and the driving unit 12 drives the first mounting plate 13 to slide relative to the second mounting plate 7. In this embodiment, the driving unit 12 and the first mounting plate 13 are not directly mounted on the battery tray 300, but the driving unit 12 and the first mounting plate 13 are mounted on the second mounting plate 7, and the second mounting plate 7 is mounted on the battery tray 300, the unlocking apparatus is conveniently assembled and arranged, and realizes modularization of the unlocking apparatus, making the unlocking apparatus more convenient to use.

There is at least one guide part between the first mounting plate 13 and the second mounting plate 7, and the first mounting plate 13 moves in the axial direction of the unlocking component 3 by means of the guide part. The guide part performs a guiding function, and the guide part makes the movement of the first mounting plate 13 on the second mounting plate 7 along the axis of unlocking component 3 more stable, which greatly improves the precision of the unlocking apparatus. In this embodiment, the first mounting plate 13 and the second mounting plate 7 are connected to each other by means of guide rail and slider.

The unlocking apparatus further comprises a second detection unit 8, the second detection unit 8 is arranged at the end of the second mounting plate 7 approaching to the unlocking component 3, the second detection unit 8 is used to detect whether the first mounting plate 13 is moved in place towards the unlocking matching member 500. When in use, the driving unit 12 moves the first mounting plate 13 forward in a direction approaching to the unlocking matching member 500. The second detection unit 8 detects whether the first mounting plate 13 is horizontally moved into place to facilitate subsequent control of the rotation of the unlocking component 3 to improve the stability of the unlocking or locking process.

In this embodiment, the driving unit 12 and the first mounting plate 13 are connected by means of the detection section 131, and the second detection unit 8 will be used to detect the position of the detection section 131. When the driving unit 12 moves the first mounting plate 13 forward in a direction towards the unlocking matching member 500, the detection portion 131 also moves forward, the second detection unit 8 can detect that the distance between the detection portion 131 becomes smaller, it means that the unlocking member 33 enters the unlocking matching member 500 and reaches the unlocking position; when the second detection unit 8 does not detect that the detection portion 131 moves to the detection area, that is, the detection portion 131 does not move to the front of the second detection unit 8 and the detection distance of the second detection unit 8 does not become small, it means that the unlocking member 33 is not aligned with the unlocking matching member 500, and the unlocking member 33 can be controlled to stop the continuous movement in time. Wherein, the shape of the detection portion 131 is L-shaped

The unlocking apparatus further comprises a third detection unit 9 arranged at one end of the second mounting plate 7 away from the unlocking matching member 500 for detecting whether the first mounting plate 13 is returned to the initial position. When in use, the driving unit 12 drives the first mounting plate 13 to move backward in the direction away from the unlocking matching member 500, and the third detection unit 9 detects the limit position at which the first mounting plate 13 is far backward, thus effectively avoiding the first mounting plate 13 from continuing to move backward and further improving the safety and stability of the unlocking apparatus; and ensures that the first mounting plate 13 is detected to return to the initial position, which is convenient for subsequent operation

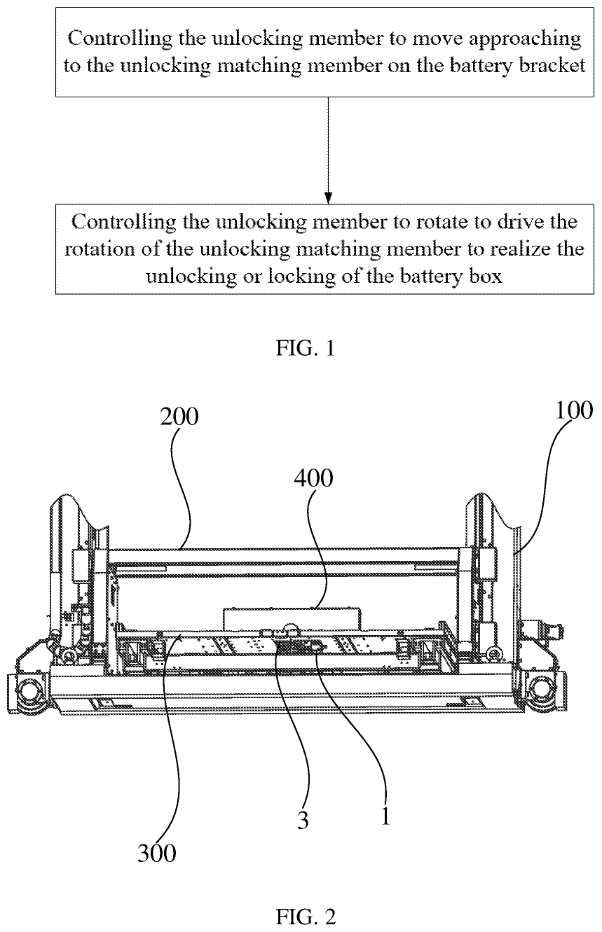

As shown in FIG. 1 to FIG. 8, the embodiment also discloses an unlocking control method which unlocks or locks the battery box in the battery bracket on the electric vehicle by means of the unlocking member 33 on the swapping device as described above. The battery bracket is arranged with a locking mechanism and an unlocking matching member 500. The locking mechanism is used for locking the battery box in the battery bracket and the unlocking matching member 500 is connected with the locking mechanism and is used for driving the locking mechanism to switch between the unlocking state and the locking state.

The unlocking control method comprises: controlling the unlocking member 33 to move approaching to the unlocking matching member 500 on a battery bracket; controlling the unlocking member 33 to rotate to drive the unlocking matching member 500 to rotate to realize the unlocking or locking of the battery box. In this step, the driving unit 12 drives the first mounting plate 13 to move approaching to the unlocking matching member 500 on the battery bracket so as to drive the unlocking member 33 to extend forward so that the unlocking member 33 is inserted into the unlocking matching member 500; the rotating unit 11 drives the drive transmission member 2 and the unlock member 33 to rotate, and the rotation of the unlock member 33 will drive the unlock matching member 500 to rotate together so as to realize the unlocking or locking of the battery box.

The unlocking matching member 500 is driven to rotate by the rotation of the unlocking member 33, so as to realize unlocking or locking of the battery box. The accuracy of the unlocking or locking is very high, which improves the efficiency of the swapping; the misoperation is effectively avoided, and the safety and stability of swapping device during unlocking or locking are greatly improved. At the same time, it prevents the unlocking member 33 from acting directly on the outer shell of the battery box, which does not affect the strength of the outer shell of the battery box, and improves the service life of the battery box.

Before controlling the rotation of the unlocking member 33 comprises: judging whether the unlocking member 33 has moved toward the unlocking matching member 500 in place; if so, controlling the unlocking member 33 to rotate. In this step, the swapping device detects and judges whether the unlocking member 33 has moved to the unlocking matching member 500 in place; when the unlocking member 33 has not moved in place, that is, the unlocking member 33 has not inserted into the unlocking matching member 500, rotating unit 11 will not drive the transmission member 2 and the unlocking member 33 to rotate, effectively avoiding misoperations, and greatly improving the safety and stability of the unlocking apparatus in the process of unlocking or locking the battery box. If the unlocking member 33 moves toward the unlocking matching member 500 in place, the rotating unit 11 will drive the transmission member 2 and the unlocking member 33 to rotate, which ensures the efficiency and stability of unlocking or locking of the battery box.

Determining whether the unlocking member 33 has moved to the unlocking matching member 500 in place specifically comprises: detecting whether the unlocking member 33 has moved to the target position. The driving unit 12 will drive the unlocking member 33 to move approaching to the unlocking matching member 500, a certain point, multiple points, one moving part or multiple moving parts in the unlocking apparatus can be used as the detection object. When the detection object moves in place, the unlocking member 33 moves in place, it means that the unlocking member 33 is inserted into the unlocking matching member 500; when the detection object is not moved in place, the unlocking member 33 is not moved in place, which means that the unlocking member 33 is not inserted into the unlocking matching member 500. By detecting whether the unlocking member 33 has moved in place to determine whether the unlocking member 33 has moved toward the unlocking matching member 500 in place, the detection is very convenient, and the detection accuracy is high, the misoperation can be effectively avoided, and greatly improving safety and stability. Of course, it is also possible to detect whether the unlocking member 33 is inserted into the unlocking matching member 500 by directly detecting the unlocking member 33 and using the unlocking member 33 as a detection object.

A first direction is the direction the unlocking member 33 moving approaching to the unlocking matching member 500 on the battery bracket, the target position comprises a first target position and/or a second target position; detecting whether the unlocking member 33 moves to the target position comprises: detecting whether the unlocking member 33 moves to the first target position in a first direction and/or; detecting whether the unlocking member 33 is moved to the second target position in a second direction opposite to the first direction.

The driving unit 12 will drive the first mounting plate 13, the transmission member 2 and the unlocking component 3 to move in a first direction. In the course of the movement, there are contact members and non-contact members on the unlocking apparatus. In the course of the movement, the non-contact members will not contact and abut against other members so that the non-contact members will move to the first target position in the first direction. The contact members will contact and abut against other members and cannot continue to move in the first direction so that the contact members move to the second target position relative to the non-contact members in a second direction opposite to the first direction.

In this embodiment, the detection portion 131, the first mounting plate 13 and the transmission member 2 will be non-contacting members and will not contact and abut against other members in the course of moving in a first direction, and the second detection unit 8 will be used to detect the detection portion 131. The unlocking member 33 is a contact member. The unlocking member 33 will be inserted into the unlocking matching member 500 to generate mutual contact force with the unlocking matching member 500 and move relative to the detection portion 131, the first mounting plate 13 and the transmission member 2 to a second target position in a second direction opposite to the first direction, the first detection unit 5 will be used to detect the compressing portion 341. By detecting the moving target position of different members, the efficiency and accuracy of the connection and alignment between the unlocking apparatus and the unlocking matching member 500 are improved, thereby improving the accuracy of unlocking or locking, effectively avoiding the occurrence of misoperation and greatly improving the safety and stability.

The unlocking member 33 comprises the compressing portion 341, detecting whether the unlocking member 33 moves to the second target position in a second direction opposite to the first direction specifically comprises: detecting whether the compressing portion 341 moves to the second target position in the second direction during the movement of the unlocking member 33 in the first direction. The unlocking member 33 needs to be inserted into the unlocking matching member 500 during the movement of the unlocking member 33 in the first direction. If the unlocking member 33 is inserted into the unlocking matching member 500, the unlocking member 33 will no longer move relative to the unlocking matching member 500, and the first mounting plate 13, the rotating unit 11 and the transmission member 2 both mounted on the first mounting plate 13 will all continue to move in the first direction so that the unlocking member 33 moves in the second direction relative to the first mounting plate 13, the rotating unit 11 and the transmission member 2 mounted on the first mounting plate 13. It is very convenient to determine whether the unlocking member 33 is inserted into the unlocking matching member 500 by detecting whether the compressing portion 341 is moved to a second target position in the second direction, and realizes the accurate operation of the unlocking apparatus, and greatly improves the safety and stability of the swapping device during the swapping process.

Detecting whether or not the compressing portion 341 moves to the second target position in the second direction while controlling the unlocking member 33 to move approaching to the unlocking matching member 500 on the battery bracket; if so, the unlocking member 33 is controlled to rotate; if not, the unlocking member 33 is controlled to retract in the second direction and the unlocking member 33 is re-controlled to move approaching to the unlocking matching member 500 on the battery bracket.

In this embodiment, the first detection unit 5 is connected to the first mounting plate 13 and moves in the first direction. When the unlocking member 33 is inserted into the unlocking matching member 500, the unlocking member 33 will be moved relative to the first detection unit in the second direction. Specifically, when the first detection unit 5 detects the compressing portion 341, it indicates that the compressing portion 341 moves to the second target position in the second direction, and the unlocking member 33 moves towards the unlocking matching member 500 in place, then the rotating unit 11 will drive the transmission member 2 and the unlocking member 33 to rotate. If the first detection unit 5 does not detect the compressing portion 341, it indicates that the compressing portion 341 dose not contact or abut in the moving process, that is, the unlocking member 33 is not inserted into the unlocking matching member 500, and the swapping device will control the driving unit 12 to retract the unlocking member 33 in the second direction, that is, retreats backward in the direction away from the unlocking matching member 500, and then re-controls the driving unit 12 to drive the first mounting plate 13, the transmission member 2 and the unlocking component 3 to move in the first direction. It is very convenient to use, and greatly improves the safety and stability of the swapping device during the battery swapping process.

In the process of detecting whether the unlocking member 33 has moved to the first target position and whether the compressing portion 341 has moved to the second target position; if it is first detected that the compressing portion 341 has moved to the second target position, then control the unlocking member 33 to retract in the second direction, and re-control the unlocking member 33 to move along the unlocking matching member 500 approaching to the battery bracket; if it is detected that the unlocking member 33 has moved to the first target position, but the compressing portion 341 has not been detected to move in place to the second target position after the preset time or stroke, the unlocking member 33 is controlled to retract in the second direction, and the unlocking member 33 is controlled to move along the unlocking matching member 500 approaching to the battery bracket.

In this embodiment, the first detection unit 5 and the second detection unit 8 are used to respectively detect whether the detection object moves to the second target position and the first target position, further improving the unlocking or locking accuracy. The first detection unit 5 and the second detection unit 8 cannot be accurately detected at the same time during the detection process. It is more stable to determine whether the unlocking member 33 has moved to the unlocking matching member 500 through the sequence.

Specifically, if the first detection unit 5 detects the compressing portion 341 first, and the second detection unit 8 has not detected the detection portion 131 or later, it indicates that the unlocking member 33 is abutted against other members rather than the unlocking matching member 500, the unlocking member 33 moves in the second direction in advance, which also shows that the unlocking member 33 is not inserted into the unlocking matching member 500, because the distance that the unlocking member 33 moves is not enough, so the swapping device will control the driving unit 12 to make the unlocking member 33 retract in the second direction, that is, retreats backward in the direction away from the unlocking matching member 500, and then re-controls the driving unit 12 to drive the first mounting plate 13, the transmission member 2 and the unlocking component 3 to move in the first direction. If the second detection unit 8 detects the detection portion 131 first, but the first detection unit 5 has not detected the compressing portion 341 within the preset time or stroke of the swapping, it means that the unlocking member 33 has not touched or abutted against the unlock matching member 500, also indicates that the unlocking member 33 is not inserted into the unlocking matching member 500, so the swapping device will control the driving unit 12 to make the unlocking member 33 retract in the second direction, that is, the direction away from the unlocking matching member 500, after that, the driving unit 12 will be re-controlled to drive the first mounting plate 13, the transmission member 2 and the unlocking component 3 to move in the first direction. If the second detection unit 8 detects the detection portion 131 first, and then the first detection unit 5 also detects the compressing portion 341 within the preset time or stroke, then it is determined that the unlocking member 33 moves to the unlocking matching member 500 in place, so that it can be controlled the rotating unit 11 performs rotating operation, so as to realize unlocking or locking of the battery box. The unlocking or locking accuracy is further improved, and the safety and stability of the swapping device during the battery swapping process are greatly improved.

After controlling the rotation of the unlocking member 33 comprises: determining whether the locking mechanism is locked or unlocked in place. In this step, the rotating unit 11 will drive the transmission member 2 and the unlocking member 33 to rotate, the unlocking member 33 will drive the unlocking matching member 500 to rotate together, and the unlocking matching member 500 will drive the locking mechanism to also move together, and the locking mechanism comprises a rotating insert, the unlocking matching member 500 drives the rotating insert to be inserted into the locking slot or retracted out of the locking slot, thereby realizing locking or unlocking of the battery box. By determining whether the locking mechanism is locked or unlocked in place, the battery box is effectively avoided from falling away when the locking mechanism is not locked in place, and the misoperation is effectively avoided in the process of taking out the battery box, which greatly improves the safety and stability of the swapping device during the swapping process.

Determining whether the locking mechanism is locked or unlocked in place specifically comprises: detecting whether the rotational torque of the rotating unit 11 falls within a preset torque range. In this step, when the rotating unit 11 rotates, the detection module can be used to detect the rotational torque of the rotating unit 11 and sends out the rotational torque value to the swapping control unit, and the swapping control unit compares and analyzes the received rotational torque value with the preset torque range. When the rotational torque value is within the preset torque range, it indicates that the unlocking member 33 is inserted into the unlocking matching member 500 and rotates in the unlocking matching member 500; when the rotational torque value is not within the preset torque range, it indicates that the unlocking member 33 is not inserted into the unlocking matching member 500, which further improves the safety and stability of the swapping device during the swapping process.

Particularly, in this embodiment, the locking mechanism needs to be inserted into the locking groove when locking, and pulls the battery box into the battery bracket so as to realize that the battery box is tightly arranged on the battery bracket, and the rotational torque value during the locking process will be within the preset torque range. When unlocking, the locking mechanism needs to be detached from the locking slot and will push the battery box out. The required rotational torque value of the battery bracket during unlocking will also be within the preset torque range.

Determining whether the locking mechanism is locked or unlocked in place specifically comprises: detecting whether the rotation amount of the rotating unit 11 falls within a preset rotation amount range. In this step, the swapping control unit controls the rotation of the rotating unit 11 and controls the rotation amount of the rotating unit 11. If the rotation amount of the rotating unit 11 falls within the preset rotation amount range, it indicates that the unlocking apparatus realizes the unlocking or locking of the battery box; if the rotation amount of the rotating unit 11 is less than the preset rotation amount range and the rotation amount of the rotating unit 11 is insufficient and can no longer continue to rotate, the unlocking or locking of the battery box fails due to jamming; if the rotation amount of the rotating unit 11 is greater than the preset rotation amount range, the rotating unit 11 can continue to rotate even if the rotation amount is greater than the preset rotation amount, which indicates that the locking mechanism has not been disengaged from the lock slot or inserted into the lock slot to unlock or fail to lock the battery box.

After controlling the unlocking member 33 to rotate, it also comprises: detecting whether the unlocking member 33 is moved to an initial position in the second direction. After unlocking or locking in place, the swapping device controls the driving unit 12 so that the first mounting plate 13, the transmission member 2 and the unlocking component 3 are moved backward to the initial position in the second direction. The unlocking apparatus is convenient for performing the next swapping operation and is convenient for repeated application.

Before controlling the movement of the unlocking member 33 to move approaching to the unlocking matching member 500 on the battery bracket, it also comprises: controlling the unlocking member 33 to be aligned with the unlocking matching member 500. Before controlling the operation of the driving unit 12, the swapping device controls the alignment of the unlocking member 33 with the unlocking matching member 500. The unlocking member 33 aligns with the unlocking matching member 500 before moving, further improving the accuracy of the unlocking apparatus in the unlocking or locking process, effectively avoiding the occurrence of misoperation and greatly improving the safety and stability.

Specifically, an unlocking member 33 is arranged on the battery tray 300 to control the alignment of the battery tray 300 with the battery bracket. Before the swapping device controls the driving unit 12, the battery tray 300 is controlled to align with the battery bracket firstly, the alignment of the unlocking member 33 and the unlocking matching member 500 is realized by the alignment between the battery tray 300 and the battery bracket. The unlocking or locking of the locking mechanism is also realized in the process of accurately taking and placing the battery box, which improves the swapping efficiency and greatly improves the safety and stability of the swapping device during the swapping process.

Controlling the alignment of the unlocking member 33 with the unlocking matching member 500 specifically comprises: obtaining the first image and the second image of at least two positions of the electric vehicle on the battery bracket; obtaining the angular rotation amount according to the first image and the second image; controlling the unlocking member 33 to adjust the angle according to the amount of rotation, until the unlocking member 33 and the unlocking matching member 500 reach a preset angle. In this step, the swapping device obtains the angular rotation amount through the first image and the second image, so that the angle is adjusted according to the current relative position of the battery bracket first, so that the unlocking member 33 and the unlocking matching member 500 reach the preset angle.

When the unlocking member 33 and the unlocking matching member 500 reach a preset angle, obtain a third image and a fourth image of at least two positions on the battery bracket; obtain a horizontal displacement and a vertical displacement according to the third image and the fourth image; control the unlocking member 33 to adjust horizontally according to the horizontal displacement, and/or control the unlocking member 33 to adjust vertically according to the vertical displacement until the unlocking member 33 and the unlocking matching member 500 reach a preset relative position. After the angle is adjusted in place, adjust in the horizontal direction and the vertical direction according to the current relative position with the battery bracket, so that the swapping device and the battery bracket are positioned. After the angle of the swapping device is adjusted in place, that is, after the swapping device is parallel to the battery bracket, the relative angle between the swapping device and the battery bracket will not be changed by the horizontal or vertical displacement of the swapping device, so that the unlocking member 33 and the unlocking matching member 500 can reach a preset relative position, which simplifies the position adjustment process of the swapping device and improves the positioning efficiency of the swapping device.

After the battery tray 300 is aligned with the battery bracket, the control further comprises: controlling the battery tray 300 to extend in a direction approaching to the battery bracket, so as to drive the unlocking member 33 to move horizontally in a direction approaching to the unlocking matching member 500. In this step, after the swapping device aligns the battery tray 300 with the battery bracket, the swapping device will control the battery tray 300 to extend in a direction approaching to the battery bracket, so that the battery tray 300 is closer to the battery box on the battery bracket, and the process of picking and placing the battery box is more stable and reliable, which greatly improves the safety and stability of the swapping device. At the same time, the unlocking apparatus is arranged at the bottom of the battery tray 300. When the battery tray 300 extends out in the direction approaching to the battery bracket, it will drive the unlocking member 33 to move horizontally in the direction approaching to the unlocking matching member 500, so that the distance between the unlocking member 33 and the unlocking matching part is smaller, which further improves the stability and reliability of the unlocking apparatus in the process of unlocking or locking, and greatly improves the safety and stability of the swapping device.

After controlling the extension of the battery tray 300 approaching to the battery bracket and before the unlocking member 33 moves approaching to the unlocking matching member 500 on the battery bracket, the control further comprises: controlling the push tray box 400 to move approaching to the battery box. The swapping device will control the push tray box 400 to move on the battery tray 300 in the direction approaching to the battery box. When the push tray box 400 extracts the battery box, the push tray box 400 will be connected to the battery box. After the subsequent locking mechanism is unlocked, the push tray box 400 will move away from the battery bracket, so that the battery box can be dragged onto the battery tray 300. When the push tray box 400 places the battery box, the push tray box 400 pushes the battery box to the battery bracket during the movement process, and after the subsequent locking mechanism is locked, the push tray box 400 will move away from the battery bracket, so that the battery box is connected to the battery bracket. Pulling or pushing the battery box by means of the push tray box 400 effectively improves the stability of picking and placing the battery box.

Although the specific implementation of the present invention has been described above, those who skilled in the art should understand that this is only an example, and the protection scope of the present invention is defined by the appended claims. Those who skilled in the art can make various changes or modifications to these embodiments without departing from the principle and essence of the present invention, but these changes and modifications all fall within the protection scope of the present invention.

1. An unlocking apparatus, which is used to unlock or lock the battery box in the battery bracket on the electric vehicle, characterized in that, the unlocking apparatus includes a drive mechanism, an unlocking component and a transmission member, and the drive mechanism drives the unlocking component to move by means of the transmission member, so that the unlocking component drives the locking mechanism on the battery bracket to move to unlock or lock the battery box;
the unlocking assembly is axially rotatable relative to the transmission member to self-adapt to the angle deviation between the unlocking component and the standard unlocking position on the battery bracket.

2. The unlocking apparatus according to claim 1, characterized in that, one end of the transmission member is connected to the drive mechanism, and the other end of the transmission member is rotatably connected to the unlocking component;
and/or, the unlocking component is able to move on the transmission member along the axial direction of the unlocking component.

3. The unlocking apparatus according to claim 2, characterized in that, the transmission member has a guide hole, and the guide hole is recessed inward from an end of the transmission member towards the unlocking component along the axial direction of the transmission member, and the unlocking component is inserted into the guide hole and is able to move in the guide hole.

4. The unlocking apparatus according to claim 3, characterized in that, the unlocking apparatus further comprises a first elastic member, the first elastic member is located in the guide hole, and the two ends of the first elastic member abut against the transmission member and the unlocking component respectively.

5. The unlocking apparatus according to claim 3, characterized in that, one end of the transmission member towards the unlocking component is clamped with the unlocking component.

6. The unlocking apparatus according to claim 5, characterized in that, an end of the transmission member towards the unlocking component is provided with a limiting portion, the unlocking component is arranged with a matching portion, and the matching portion is connected in the limiting portion and is able to rotates relative to the limiting portion along the axis of the unlocking component;
or, an end of the transmission member towards the unlocking component is provided with a matching portion, and the unlocking component is arranged with a limiting portion, the limiting portion is connected in the matching portion and is able to move along the axis of the unlocking component relative to the matching portion.

7. The unlocking apparatus according to claim 6, characterized in that, the limiting portion is an opening arranged on the outer wall of the transmission member, and the opening communicates with the guide hole;
and/or, the matching portion is a slider arranged on the unlocking component.

8. The unlocking apparatus according to claim 7, characterized in that, a length of the opening along the axial direction of the transmission member is greater than an extension length of the slider along the axial direction of the transmission member;
and/or, a length of the opening along the radial direction of the transmission member is greater than an extension length of the slider along the radial direction of the transmission member.

9. The unlocking apparatus according to claim 1, characterized in that, the unlocking component itself is radially displaceable, so that the unlocking component can move radially relative to the drive mechanism.

10. The unlocking apparatus according to claim 9, characterized in that, the unlocking component comprises a radially twistable second elastic member and an unlocking member, both ends of the second elastic member are respectively connected to the transmission member and the unlocking member, and the second elastic member is adapted to the radial displacement of the unlocking member.

11. The unlocking apparatus according to claim 10, characterized in that, an end of the unlocking member towards away from the transmission member is provided with an insertion end, and the insertion end is used to connect and match the unlocking matching member of the locking mechanism on the battery bracket;
and/or, an end of the unlocking member towards the second elastic member comprises a connecting groove extending along the axial direction of the unlocking member, and the unlocking member is connected to the second elastic member by means of the connecting groove.

12. The unlocking apparatus according to claim 11, characterized in that, an outer surface of the insertion end comprises at least one abutment surface, the battery bracket is arranged with an unlocking matching member, and the unlocking matching member is connected with the locking mechanism, the insertion end is used to insert into the unlocking matching member, and the abutment surface matches an inner wall surface of the unlocking matching member, so as to drive the unlocking matching member to rotate;
and/or, an end of the insertion end towards away from the transmission member is provided with a sliding guide surface, the sliding guide surface is connected to the abutment surface and used for guiding the unlocking member to be inserted into the unlocking mating member.

13. The unlocking apparatus according to claim 10, characterized in that, the unlocking component further comprises a connecting sleeve, one end of the connecting sleeve is connected to the second elastic member, and the other end of the connecting sleeve is connected to the transmission member.

14. The unlocking apparatus according to claim 13, characterized in that, an end of the connecting sleeve towards the transmission member is rotatably connected to the transmission member;
and/or, the connection sleeve is clamped with the transmission member.

15. The unlocking apparatus according to claim 1, characterized in that, the unlocking apparatus further comprises a first detection unit for detecting whether the unlocking component moves in the direction approaching to the drive mechanism;
and/or, a compression portion is further arranged on the unlocking component, and the first detection unit is used to detect the position of the compression portion.

16. The unlocking apparatus according to claim 1, characterized in that, the drive mechanism comprises a rotating unit, the rotating unit is connected to the transmission member by means of a coupling sleeve and is used to drive the unlocking component to rotate along the axis of the unlocking component.

17. The unlocking apparatus according to claim 16, wherein the driving mechanism further comprises a detection module, the detection module is electrically connected to the rotating unit and used to detect rotational torque of the rotating unit.

18. The unlocking device according to claim 16, characterized in that, the unlocking apparatus further comprises a mounting seat, and the rotating unit is penetrated on the mounting seat.

19. The unlocking apparatus according to claim 18, characterized in that, a limiting hole is provided in the mounting seat, and the transmission member is inserted into the limiting hole and connected with the rotating unit;
and/or, a bearing is provided in the limiting hole, and the bearing is sleeved on the transmission member.

20. The unlocking apparatus according to claim 18, characterized in that, the drive mechanism further comprises a drive unit and a first mounting plate, the mounting seat is connected to the first mounting plate, and the drive unit is connected to the first mounting plate and is used to drive the first mounting plate to move along the axial direction of the unlocking component.

21. The unlocking apparatus according to claim 20, characterized in that, the unlocking apparatus further comprises a second mounting plate, the drive unit is arranged on the second mounting plate, and the drive unit drives the first mounting plate to slide relative to the second mounting plate.

22. The unlocking apparatus according to claim 21, characterized in that, at least one guide part is provided between the first mounting plate and the second mounting plate, and the first mounting plate moves along the axial direction of the unlocking component by means of the guide part;
and/or, the unlocking apparatus further comprises a second detection unit, the second detection unit is arranged at an end of the second mounting plate approaching to the unlocking component, and the second detection unit is used to detect whether the first mounting plate is moved in place in the direction of the locking mechanism;
and/or, the unlocking apparatus further comprises a third detection unit, the third detection unit is arranged at an end of the second mounting plate away from the locking mechanism, and the third detection unit is used to detect whether the first mounting plate returns to an initial position.

23. A swapping device, characterized in that it comprises the unlocking apparatus according to claim 1.

24. The swapping device according to claim 23, characterized in that further comprising a battery tray, and the unlocking apparatus is connected to the battery tray.

25. An unlocking control method, unlocking or locking the battery box in the battery bracket on the electric vehicle by means of the unlocking member of the swapping device, the battery bracket is arranged with a locking mechanism and an unlocking matching member, and the locking mechanism is used to lock the battery box in the battery bracket, and the unlocking matching member is connected with the locking mechanism and used to drive the locking mechanism to switch between an unlocked state and a locked state, characterized in that, the unlocking control methods comprises:
controlling the unlocking member to move approaching to the unlocking matching part on the battery bracket;
controlling the unlocking member to rotate to drive the rotation of the unlocking matching member to realize the unlocking or locking of the battery box;
before controlling the rotation of the unlocking member, comprises:
determining whether the unlocking member has moved to the unlocking matching member in place;
if so, then controlling the unlocking member to rotate;
determining whether the unlocking member moves to the unlocking matching member in place specifically comprises:
detecting whether the unlocking member moves to a target position;
the moving direction of the unlocking member approaching to the unlocking matching member on the battery bracket is a first direction, and the target position comprises a first target position location and/or a second target location;
detecting whether the unlocking member moves to the target position comprises:
detecting whether the unlocking member moves to the first target position along the first direction, and/or;
detecting whether the unlocking member moves to the second target position along a second direction opposite to the first direction.

26. (canceled)

27. (canceled)

28. (canceled)

29. The unlocking control method according to claim 25, characterized in that, the unlocking member comprises a compression portion, and detecting whether the unlocking member moves to the second target position along the second direction opposite to the first direction specifically comprises:
detecting whether the compression portion moves to the second target position along the second direction during the movement of the unlocking member in the first direction.

30. The unlocking control method according to claim 29, characterized in that, during the process of controlling the unlocking member to move approaching to the unlocking matching member on the battery bracket, detecting whether the compression portion moves along the second directions to the second target position;
if so, controlling the unlocking member to rotate;
if not, controlling the unlocking member to retract along the second direction, and re-controlling the unlocking member to move approaching to the unlocking matching member on the battery bracket;
and/or, during the process of detecting whether the unlocking member moves to the first target position and detecting whether the compression portion moves to the second target position;
if it is first detected that the compressing portion moves to the second target position, then control the unlocking member to retract along the second direction, and re-control the unlocking member to move approaching to the unlocking matching member on the battery bracket;
if it is detected that the unlocking member has moved in place to the first target position, but the compression portion has not been detected to move in place to the second target position after a preset time or stroke, then the unlocking member is controlled to retract along the second direction, and the unlocking member is re-controlled to move approaching to the unlocking matching member on the battery bracket.

31. The unlocking control method according to claim 25, characterized in that, after controlling the unlocking member to rotate, it comprises:
determining whether the locking mechanism is locked or unlocked in place.

32. The unlocking control method according to claim 31, characterized in that, determining whether the locking mechanism is locked or unlocked in place specifically comprises:
detecting whether a rotational torque of the rotating unit falls within a preset torque range;
and/or, determining whether the locking mechanism is locked or unlocked in place specifically comprises:
detecting whether a rotation amount of the rotating unit falls within a preset rotation amount range.

33. The unlocking control method according to claim 25, characterized in that, after controlling the rotation of the unlocking member, it further comprises:
detecting whether the unlocking member moves to an initial position along away from the unlocking matching member on the battery bracket.

34. The unlocking control method according to claim 25, characterized in that, before controlling the unlocking member to move approaching to the unlocking matching member on the battery bracket, the method further comprises:
controlling the unlocking member to align with the unlocking matching member.

35. The unlocking control method according to claim 34, characterized in that, controlling the unlocking member to align with the unlocking matching part specifically comprises:
obtaining a first image and a second image of at least two positions of the electric vehicle on the battery bracket;
obtaining an angular rotation amount according to the first image and the second image;
controlling the unlocking member to adjust the angle according to the angular rotation amount until the unlocking member and the unlocking matching member reach a preset angle;
and/or, when the unlocking member and the unlocking matching member reach the preset angle, obtaining a third image and a fourth image of at least two positions on the battery bracket;
obtaining a horizontal displacement and a vertical displacement according to the third image and the fourth image;
controlling the unlocking member to adjust horizontally according to the horizontal displacement, and/or control the unlocking member to adjust vertically according to the vertical displacement until the unlocking member and the unlocking matching member reach a preset relative position.

36. The unlocking control method according to claim 34, characterized in that, the unlocking member is arranged on a battery tray, controlling the battery tray to align with the battery bracket.

37. The unlocking control method according to claim 36, characterized in that, after controlling the battery tray to align with the battery bracket, it further comprises:
controlling the battery tray to extend in a direction approaching to the battery bracket, so as to drive the unlocking member to move horizontally in a direction approaching to the unlocking matching member;
and/or, after the battery tray is controlled to extend in a direction approaching to the battery bracket, and before the unlocking member moves approaching to the unlocking matching member on the battery bracket, the method further comprises:
controlling a push tray box to move in a direction approaching to the battery box.
